(19) United States
(12) Patent Application Publication
(10) Pub. No.: US 2012/0292515 A1
(43) Pub. Date: Nov. 22, 2012

(54) PANEL SUPPORT PLATE AND DETECTOR AND X-RAY IMAGING SYSTEM

(76) Inventors: Hongye ZHANG, Beijing (CN); Liang ZHANG, Beijing (CN)

(21) Appl. No.: 13/475,597

(22) Filed: May 18, 2012

(30) Foreign Application Priority Data
May 20, 2011 (CN) 201110146903.7

(51) Int. Cl. G01T 7/00; G01T 1/20

(52) U.S. Cl. 250/361 R; 378/189

(57) ABSTRACT

A panel support plate for supporting a detection panel within an X-ray detector is provided. The panel support plate comprises a shock absorption space, a portion of which is in contact with an internal edge of a housing of the detector.

### BACKGROUND OF THE INVENTION

1. Field of the Invention

Embodiments of the present invention generally relate to the field of compact digital X-ray imaging, and, more particularly, to a panel support plate and a detector and an X-ray imaging system.

2. Description of the Related Art

As the technique of X-ray imaging system develops continuously, it gains an increasingly broad. application in the medical field. At present, a growing number of digital X-ray imaging systems have taken the place of conventional film type X-ray imaging systems. In the digital X-ray imaging system, a compact detector is mostly used so as to be moved and adjusted when imaging a patient.

As for a compact detector, a digital detector panel is placed in a housing, as shown in FIG. 1, which shows a diagram of a known detector panel. As seen from FIG. 1, a known detector comprises a detection panel 1, a scintillator layer 2, a main circuit board layer 3, a flexible circuit module 5, a panel support plate 4 and a housing 6. The detection panel 1 is the core element of the X-ray detector, the scintillator layer 2 attached thereon is primarily used for converting incident X-ray into visible light. The visible light may directly irradiate on the photodiode device on the surface of the detection panel 1 and an analog electrical signal is generated. The analog electrical signal is converted into a digital signal through the flexible circuit module 5 connected to the detection panel 1 and is transferred to the main circuit board 3 for processing. Because the detection panel is a fragile material, in order to increase the lifespan and strength of the X-ray detector, a panel support plate 4 is added between the detection panel 1 and the main circuit board 3, and the internal elements are protected by a housing 6 formed by machining a metal material with high strength and low density. Finally, a complete X-ray detector is formed.

When implementing digital X-ray imaging upon a patient, the detector needs to be moved according to the part to be imaged and the health condition of the patient so that the detector is placed in a position where the best image can be presented. Thus, inevitably, the detector may be impacted by external force, falling down to the ground without caution, and so on. It is known that the detection panel 1 in the detector may be damaged after being impacted by external force and so on. As a result, how to cushion the external force has become an area of intense study in the field.

At present, an elastic damper block, a support block and etc. are mostly used, which are additionally mounted to the four corners along the internal edge within the detection housing in order to absorb external force.

The addition of an extra component, i.e. an elastic damper block, mounted in the detector increases the weight and cost of the whole detector. Thus decreasing the portability of the detector and increasing the complexity of production and assembly.

Furthermore, because an elastic damper block may drop off, the reliability of the detector cannot be ensured.

In view of the foregoing, there exists a need to provide a panel support plate and detector and X-ray imaging system that achieve the capability of shock absorption and shock resistance without increasing the weight and cost of the a panel support plate and detector and X-ray imaging system.

### BRIEF SUMMARY OF THE INVENTION

According to an embodiment of the invention, a panel support plate for supporting a detection panel within an X-ray detector is provided. The panel support plate comprises a shock absorption space, a portion of which is in contact with an internal edge of a housing of the detector.

According to another embodiment of the invention, a detector is provided. The detector comprises a detection panel, a scintillator layer, a main circuit board, a flexible circuit module connected to the detection panel and the main circuit board, and a panel support plate configured to support the detection panel, the panel support plate comprising a shock absorption space, a portion of which is in contact with an internal edge of the housing of the detector, wherein X-rays, after irradiating on the scintillator layer, are converted into a visible light signal, and then the visible light signal is received by the detection panel.

According to another embodiment of the invention, an X-ray imaging system comprising a detector is provided. The detector comprises a detection panel, a scintillator layer, a main circuit board, a flexible circuit module connected to the detection panel and the main circuit board, and a panel support plate configured to support the detection panel, the panel support plate comprising a shock absorption space, a portion of which is in contact with an internal edge of the housing of the detector, wherein X-rays, after irradiating on the scintillator layer, are converted into a visible light signal, and then the visible light signal is received by the detection panel.

### BRIEF DESCRIPTION OF THE DRAWINGS

In order to understand the present disclosure more thoroughly, reference is made to the following descriptions taken in conjunction with the figures, in which:

FIG. 1 is a schematic diagram of the structure of a conventional X-ray;

FIG. 2 is a schematic diagram of the detector according to an embodiment of the present invention;

FIG. 3 is a partial top view of the I part in FIG. 2;

FIG. 4 is a schematic diagram of the panel support plate according to an embodiment of the present invention which is subjected to a impact force;

FIG. 5 is a schematic diagram of a shock absorption space of honeycomb structure according to an embodiment of the panel support plate;

FIG. 6 is a schematic diagram of a shock absorption space of multiple pores with irregular structure according to an embodiment of the panel support plate.

### DETAILED DESCRIPTION OF THE INVENTION

Embodiments of the present invention will be described in detail below. However, the present invention is not limited to the embodiments stated as follows. Instead, the scope of the invention is defined by the appended claims.

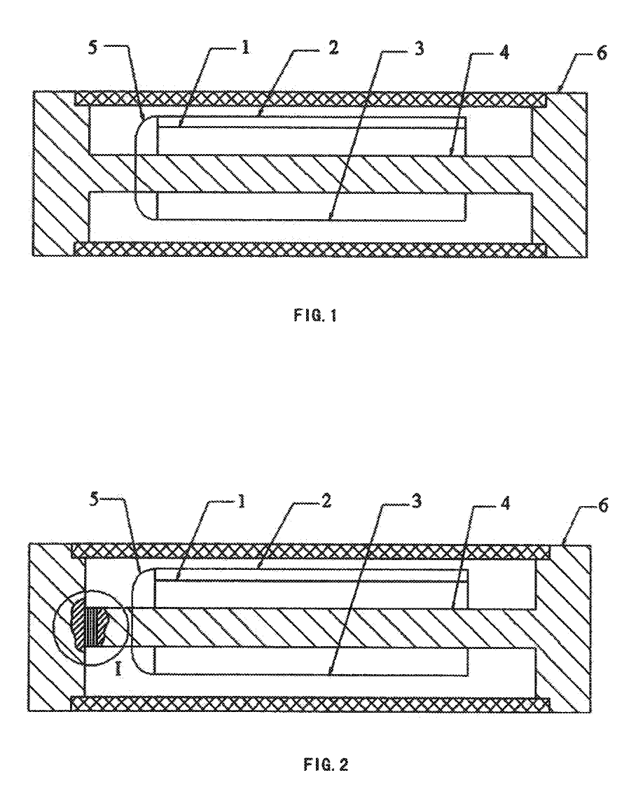

In one aspect of the present invention, a panel support plate 4 is disclosed, which is used for supporting a detection panel 1. within an X-ray detector, as shown in FIG. 2. The panel support plate 4 comprises a shock absorption space, a portion of which is in contact with the internal edge of the housing 6.

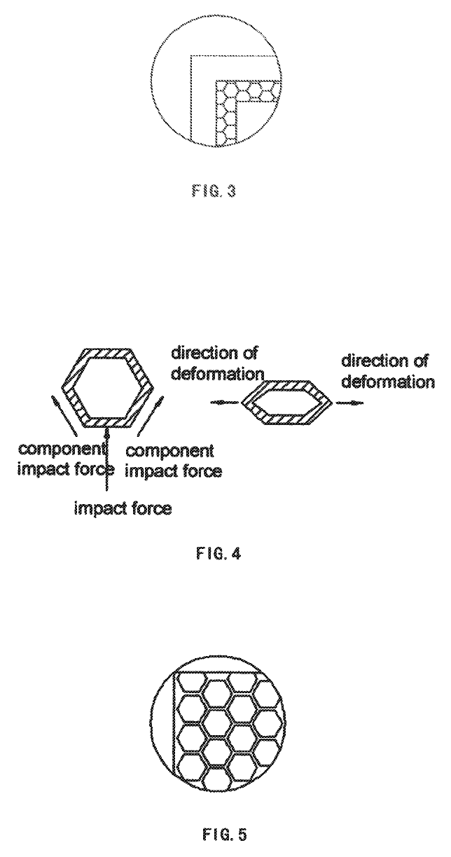

FIG. 3, is a partial top view of the I part in FIG. 2. That is, it is a partial diagram of the portion in which the panel support plate, according to an embodiment of the present invention, is in contact with the internal edge of the housing of the detector. As seen from FIG. 3, the shock absorption space comprises pores. When force is applied to the edge of the panel support plate 1, the pores will be deformed after being subjected to the impact force. The impact force can he dispersed along the walls of the pores, thereby performing the function of shock absorption.

The pores shown in FIG. 4 are of honeycomb structure. However, any pore structure known by those skilled in the art may be adopted. Due to the particularity of the honeycomb structure, the impact force will be transferred along the edge of the honeycomb structure, thus causing the deformation of the honeycomb structure. In addition, the intensive impact force will be decomposed to comparatively small component forces, and thus is unlikely to be directly applied to the edge of the detection panel. The compression and deformation of the edge of the panel support plate reduces the probability of damaging the detection panel due to extrusion deformation.

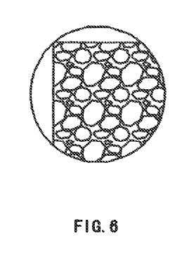

The shock absorption space may be comprised of multiple pores with regular structure or multiple pores with irregular structure. As shown in FIG. 6, the shock absorption space comprises a variety of pores with different shapes. Again, as shown in FIG. 5, it shows honeycomb-like pores. Those skilled in the art shall know clearly that any other shape, such as the micro-type round hole shape and so on, also may be adopted for the pores.

In addition, the shock absorption space and the other potions of the panel support plate according to the present disclosure may be made of the same material, and also may be made of different materials. According to another embodiment, as shown in FIG. 2, a detector, comprising a detection panel 1, a scintillator layer 2, a flexible circuit module 5, a main circuit board 3, a panel support plate 4 and a housing 6 accommodating the aforesaid elements is provided. The X-ray, after irradiating on said scintillator layer 2, is converted into an electrical signal and then the electrical signal is received by said detector panel 1. The panel support plate 4 is used for supporting the detection panel 1. The flexible circuit module 5 is connected to the detection panel 1 and the main circuit board 4. The panel support plate 4 comprises several shock absorption spaces, a portion of which is in contact with the internal edge of the housing 6 of the detector.

The shock absorption spaces are of multiple pores with regular structure or multiple pores with irregular structure. Additionally, although the honeycomb is the preferred structure of the pores may be of other shapes, such as micro-type round hole shape and so on.

Further, said shock absorption spaces and the other portions of said panel support plate may be made of the same material, and also may be made of different materials.

Because the technical solution of the panel support plate 4 in the detector according to the present invention corresponds to the technical solution of the panel support plate according to the present invention, here the technical solution of the detector according to the present disclosure will not be stated in detail.

In another embodiment of the present invention, an X-ray imaging system comprising the detector is disclosed.

In summary, embodiments of the present invention resist impact of external force by changing the internal structure of the panel support plate without adding any additional component such as an elastic damper block or the like. This reduces the whole cost of the detector.

Also, embodiments of the panel support plate are comprised of several cell-shaped shock absorption spaces, a portion of which is in contact with the internal edge of the housing of the detector. In other words, the shock absorption spaces and the panel support plate are integrated, such that the problem in the prior art where the elastic damper block drops off will not occur. This results in enhanced reliability.

Additionally, since each shock absorption space has interspaces therein, the impact force will be decomposed by each shock absorption space and changed in direction, in addition, the energy of shock wave will be cushioned due to deformation and compression of the shock absorption space, and as a result, it will not be directly transferred to the detection panel. This greatly enhances the shock resistance and shock absorption capability of the detector panel.

Furthermore, embodiments of the present invention absorbs shock by making full use of the characteristics of the mechanical structure, belonging to rigid shock absorption design, which is completely different from the conventional elastic shock absorption of the X-ray detectors found in the prior art.

Although the embodiments of the present invention are described as above in combination with the figures, those skilled in the art may implement various variation, modification and equivalent substitution to the present invention without deviating from the spirit and scope of the present invention. It is intended that such variation, modification and equivalent substitution intend to fall within the spirit and scope defined by the appended claims.

What is claimed is:

1. panel support plate for supporting a detection panel within an X-ray detector, the panel support plate comprising a shock absorption space, a portion of which is in contact with an internal edge of a housing of the detector.

2. The panel support plate of claim 1, wherein the shock absorption space comprises imiltiple pores with regular structure.

3. The panel support plate of claim 2, wherein the pores are honeycomb structure.

4. The panel support plate of claim 2, wherein the pores are micro-type round hole shaped.

5. The panel support plate of claim 1, wherein the shock absorption space comprises imiltiple pores with irregular structure.

6. The panel support plate of claim 5, wherein the pores are honeycomb structure.

7. The panel support plate of claim 5, wherein the pores are micro-type round hole shaped.

8. The panel support plate of claim 1, wherein the shock absorption space and other portions of the panel support plate are made of the same material.

9. The panel support plate of claim 1, wherein the shock absorption space and other portions of the panel support plate are made of different materials.

10. A detector comprising:
a detection panel;
a scintillator layer;
a main circuit board;
a flexible circuit module connected to the detection panel and the main circuit board; and
a panel support plate configured to support the detection panel, the panel support plate comprising a shock absorption space, a portion of which is in contact with an internal edge of the housing of the detector,
wherein X-rays, after irradiating on the scintillator layer, are converted into a visible light signal, and then the visible light signal is received by the detection panel.

11. The detector of claim 10, wherein the shock absorption space comprises multiple pores with regular structure.

12. The detector of claim 11, wherein the pores are honeycomb structure.

13. The detector of claim 11, wherein the pores are micro-type round hole shaped.

14. The detector of claim 10, wherein the shock absorption space comprises multiple pores with irregular structure.

15. The detector of claim 14, wherein the pores are honeycomb structure.

16. The detector of claim 14, wherein the pores are micro-type round shaped.

17. he detector of claim 10, wherein the shock absorption space and other portions of said panel support plate are made of the same material.

18. The detector of claim 10, wherein the shock absorption space and other portions of said panel support plate are made of different materials.

19. An X-ray imaging system comprising a detector comprising:
a detection panel;
a scintillator layer;
a main circuit board;
a flexible circuit module connected to the detection panel and the main circuit board; and
a panel support plate configured to support the detection panel, the panel support plate comprising a shock absorption space, a portion of which is in contact with an internal edge of the housing of the detector,
wherein X-rays, after irradiating on the scintillator layer, are converted into a visible light signal, and then the visible light signal is received by the detection panel.
